(19) United States
(12) Patent Application Publication
(10) Pub. No.: US 2011/0033021 A1
(43) Pub. Date: Feb. 10, 2011

(54) SYSTEM, METHOD AND APPARATUS FOR COUNTING STACKED OBJECTS

(76) Inventor: Timothy A. Freriks, Tampa, FL (US)

Correspondence Address: LARSON AND LARSON, 11199 69TH STREET NORTH, LARGO, FL, 33773, US

(21) Appl. No.: 12/536,022

(22) Filed: Aug. 5, 2009

(51) Int. Cl. G06M 9/00; G01F 15/06; G01B 7/00

(52) U.S. Cl. 377/8; 377/19; 377/24

(57) ABSTRACT

An application for a device for directly measuring the number of homogeneous objects in a linear collection of homogeneous objects. In a preferred embodiment, the device is an elongated object having one or more sets of gradients in which each set of gradients corresponds to a specific type of homogeneous objects and each gradient represents a specific count of the specific type of homogeneous objects

### FIELD OF THE INVENTION

This invention relates to the field of measurement and more particularly to a system and device for counting sheets in a stack.

### BACKGROUND

Rulers and calipers are well known in the industry and very well capable of measuring distances or the thickness of various objects. In general, such measuring devices have gradients marked along an edge, each gradient representing a unit of a standard measure such as inches, fractions of an inch, millimeters, centimeters, etc. By aligning the measuring device next to an object, one can easily determine the dimensions of the object. The dimension of the object is in standard measurements such as inches or millimeters.

When counting a linear collection of objects, such as a stack of paper, the prior art measuring devices only provide a thickness measurement but do not provide a count of how many of such objects are in the linear collection. When all of the objects in the linear collection are of a homogeneous thickness, then the number of such objects in a stack is directly related to the thickness of the stack. For example, if a stack of ¾″ plywood is two feet tall, then there should be 32 sheets of plywood in the stack. In a lumber yard, to perform inventory on stacks of lumber or when at the check-out, often one would count the sheets by hand to determine the inventory level or what to charge the customer. Based upon prior art, one could, instead, measure the thickness of the stack and convert the thickness into the number of sheets, but this often requires manual division or the use of a calculator and, is therefore often not done.

What is needed is a system that will directly count the number of objects in a collection.

### SUMMARY OF THE INVENTION

A device is disclosed for directly measuring the number of homogeneous objects in a linear collection of homogeneous objects (objects having the same thickness). In a preferred embodiment, the device is an elongated object having one or more sets of gradients in which each set of gradients corresponds to a specific type of homogeneous objects and each gradient represents a specific count of the specific type of homogeneous objects.

In one embodiment, a counting device is disclosed including an elongated body that has a first end, a second end, a front surface, a back surface, a first side edge and a second side edge. A plurality of gradients are marked on the front surface of the elongated body, the gradients are proximal to at least one of the first and second side edges and are spaced and labeled corresponding to a specific set of homogeneous objects to be counted. Each gradient represents a number of the homogeneous objects to be counted

In another embodiment, a method of counting homogeneous objects is disclosed including providing a counting device that has an elongated body with a first end, a second end, a front surface, a back surface, a first side edge and a second side edge. A plurality of gradients is situated on a surface of the elongated body with at least some of the gradients in proximity to at least one of the first and second side edges. The gradients are spaced and labeled according to a specific set of homogeneous objects to be counted and each gradient represents a number of the homogeneous objects to be counted. The counting device is placed next to a linear collection of the homogeneous objects such that the first end of the elongated body is positioned next to a first end object of the linear collection of homogeneous objects. A count of the homogeneous objects is read from a gradient marker that aligns with a distal end object of the linear collection of the homogeneous objects.

In another embodiment, a counting device is disclosed including an apparatus for measuring a height of a stack of homogeneous objects that has a means for measuring that directly indicates a number of the homogeneous objects in a stack of homogeneous objects.

### BRIEF DESCRIPTION OF THE DRAWINGS

The invention can be best understood by those having ordinary skill in the art by reference to the following detailed description when considered in conjunction with the accompanying drawings in which:

FIG. 1A illustrates a perspective view of a device of the present invention.

FIG. 1B illustrates a perspective view of the device of the present invention held next to a linear collection of objects.

FIG. 2A illustrates a perspective view of the device of the present invention with an optional caliper.

FIG. 2B illustrates a perspective view of the device of the present invention with an optional caliper held next to a linear collection of objects.

FIG. 3A illustrates a plan view of the present invention calibrated for coated paper.

FIG. 3B illustrates a plan view of the present invention calibrated for card stock.

FIG. 4 illustrates a plan view of the present invention calibrated for several stacked objects.

FIG. 5 illustrates a plan view of the present invention calibrated for a set of stacked paper objects.

FIG. 6A illustrates a plan view of the present invention calibrated for cover paper.

FIG. 6B illustrates a plan view of the present invention calibrated for plain paper.

FIG. 7 illustrates a plan view of the present invention calibrated for a set of stacked paper objects shown measuring a number of objects in the stack.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Although the present invention is described with respect to one particular measuring device (an elongated, ruler-like device that counts instead of measures), it is anticipated that the present invention is applicable and useful with many other modes of measurement including, but not limited to, calipers, ultrasonic rulers, laser rulers, etc. For example, a laser or ultrasonic distance measuring device of the prior art will tell a builder the distance from one wall to another in inches, feet, meters, etc, while using the methods disclosed herein, such a device is adapted to measure a number of sections of 4′×8′ sheet rock needed for the wall or the number of rolls of wallpaper needed to cover the sheetrock or the number of gallons of paint needed to cover the walls, etc.

In general, the device of the present invention is described for counting a collection, stack, row, column or linear collection of homogeneous objects. A collection, for the remainder of this specification, refers to any such set of homogeneous objects. The objects are homogeneous in thickness, but not necessarily in length or width. An example of one such homogeneous collection is wooden dowels (or pencils) arranged in a linear row. In such, the dowels are easily counted using the present invention even if some are shorter/longer than the others. The collection is also anticipated to be, in some situations, multidimensional. An example of such is a storage bin of pipes, each pipe being of equal diameter. In such, a count of the number of pipes in the storage bin is accomplished by using the present invention to count the number of pipes in an end column and the number of the pipes an end row then multiplying the two counts to determine the number of pipes in the collection.

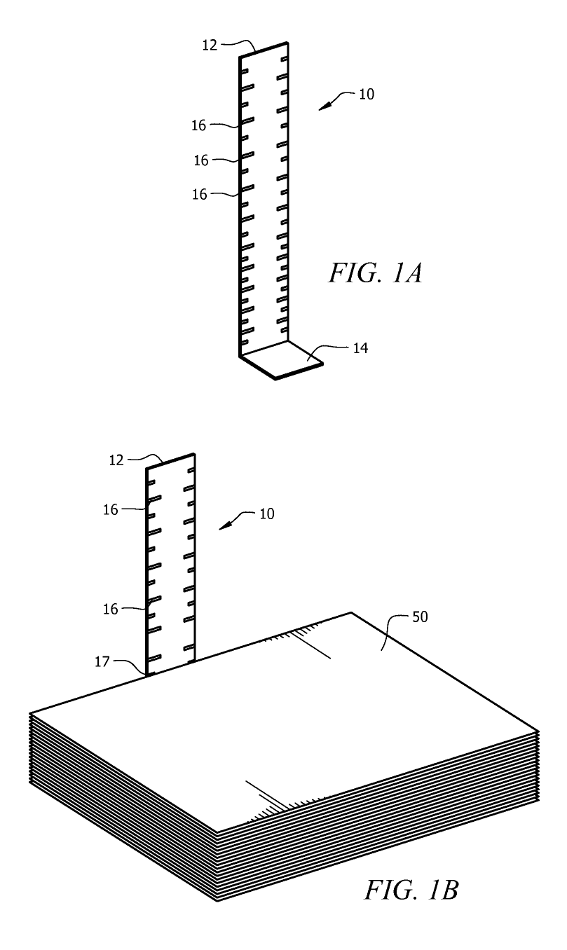

Referring to FIG. 1A, a perspective view of a device of the present invention is shown. The counting device 10 of the present invention includes an elongated body 12, which in this example, is an elongated, flat, stiff piece of material. It is anticipated that the linear counting section 12 is such that it conforms to the linear collection of objects to be counted, both in dimension and hardness, in some embodiments being flexible to allow for irregular shaped objects. For the remainder of the description, though, a stiff counting device 10 is shown for counting the number of objects that are stacked (e.g. sheets 50 as in FIG. 1B).

In this example, the counting device 10 has a bottom ledge 14 for registering against an end object of the linear collection of objects. The bottom ledge 14 is optional and when present, is of a size sufficient to interface with a bottom edge of the first object in a linear collection of objects. For example, the bottom ledge 14 need only be a few millimeters deep for counting a linear collection (stack) of paper or plywood 50, but another bottom ledge 14 need be equal to or greater than the radius of an end pipe in a stack of pipes, such as a stack of PVC pipes (not shown).

The counting device 12 has gradients 16 along its surface. The gradients 16 are calibrated to count the number of a certain object in a linear collection or stack. For example, one set of gradients 16 is calibrated to count the number of sheets of a certain weight paper 50 in a stack. In another example, the gradients 16 are calibrated to count the number of sheets of ¾″ plywood 50 in a stack. It is anticipated that multiple sets of gradients 16 are printed on the counting device 12 for counting linear collections or stacks of different objects. For example, one set of gradients 16 shows the number of sheets of 60# paper and another set of gradients shows the number of sheets of 80# paper. In another example, one set of gradients 16 shows the number of sheets of ¾″ plywood, another set of gradients shows the number of sheets of ½″ plywood, another set of gradients (on the reverse side) shows the number of sheets of ¼″ plywood and another set of gradients shows the number of sheets of 1″ plywood. It is anticipated that, in some embodiments, the counting device 10 has different sets of gradients 16 for counting different types of object such as, one set of gradients 16 for counting paper and one set of gradients 16 for counting a row of pencils. In this example, the pencils need not be of similar length, but should be of the same or similar thickness for an accurate count. It is anticipated that, when gradients are on both sides, a ledge 14 is optionally provided on both sides as well.

Referring to FIG. 1B, a perspective view of the device of the present invention held next to a linear collection of objects 50 is shown. The counting device 10 is positioned next to the linear collection of objects 50 and the number of objects in the linear collection of objects 50 is read by the gradient 17 next to the top object of the linear collection of objects 50. In this example, the linear collection of objects 50 is a stack of sheets such as paper, cardboard stock, plastic sheets, plywood, particle board, etc.

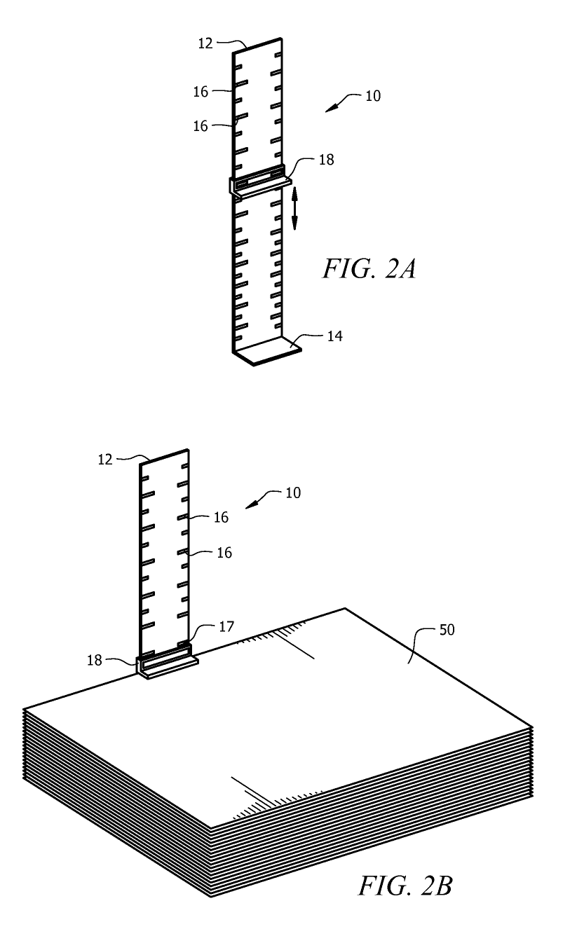

Referring to FIG. 2A, a perspective view of the device of the present invention with an optional caliper 18 is shown. The counting device 10 of the present invention includes a linear count section 12, which in this example is an elongated flat, stiff piece of material 10. In this example, the counting device 10 has a bottom ledge 14 for registering against an end object of the linear collection of objects 50. The bottom ledge 14 is optional and when present, is of a size sufficient to interface with a bottom edge of the first object in a linear collection of objects 50. For example, the bottom ledge 14 need only be a few millimeters deep for counting a linear collection (stack) of paper or plywood 50, but another bottom ledge 14 need be equal to or greater than the radius of an end pipe in a stack of pipes, such as a stack of PVC pipes.

The counting device 12 has gradients 16 along its surface. The gradients 16 are calibrated to count the number of a certain object in a linear collection or stack 50. For example, one set of gradients 16 is calibrated to count the number of sheets of a certain weight paper 50 in a stack. In another example, the gradients 16 are calibrated to count the number of sheets of ¾″ plywood 50 in a stack. It is anticipated that multiple sets of gradients 16 are printed on the counting device 12 for counting linear collections or stacks of different objects. For example, one set of gradients 16 shows the number of sheets of 60# paper and another set of gradients shows the number of sheets of 80# paper. In another example, one set of gradients 16 shows the number of sheets of ¾″ plywood, another set of gradients shows the number of sheets of ½″ plywood, another set of gradients (on the reverse side) shows the number of sheets of ¼″ plywood and another set of gradients shows the number of sheets of 1″ plywood. It is anticipated that, when gradients are on both sides, a ledge 14 is optionally provided on both sides as well.

In this example, a caliper 18 is provided, slideably engaged with the counting device 12. The caliper 18 is sized to engage with an end object in the linear collection of objects 50. For example, for counting flat objects such as sheets of paper or plywood, the caliper 18 is only a few millimeters thick, while for counting other objects, such as linear collections of pipes (e.g. a row or column of pipes organized in a storage bin), the caliper 18 is deeper, at least as deep as the radius of the largest pipe to be measured.

Referring to FIG. 2B, a perspective view of the device of the present invention with an optional caliper 18 held next to a linear collection of objects is shown. The counting device 10 is positioned next to the linear collection of objects 50 and the number of objects in the linear collection of objects 50 is read by the gradient 17 next to the caliper 18. It is anticipated that the gradients 16 be offset to account for the height of the caliper 18 or the reading of the gradient 16 be made from an opposite side (e.g. the side not visible in FIG. 2B). In this example, the linear collection of objects 50 is a stack of sheets such as paper, cardboard stock, plastic sheets, plywood, particle board, etc.

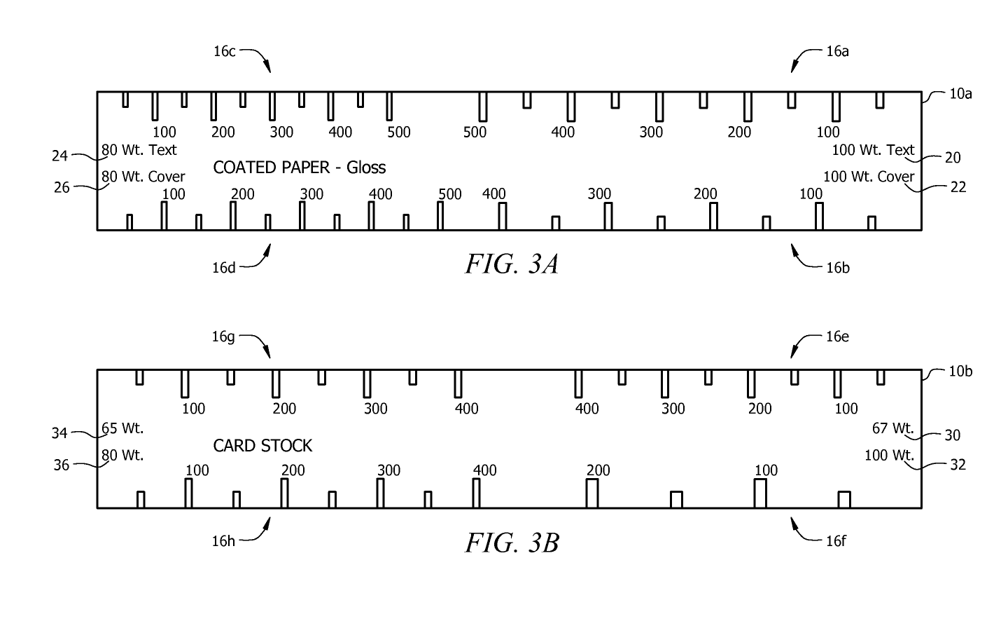

Referring to FIG. 3A, a plan view of the present invention calibrated for coated paper is shown. In this example, the counting device 10a has gradients 16 for measuring the number of sheets of coated paper in a stack. A first set of gradients 16a counts the number of 100 weight coated paper text sheets 20 using the right edge of the counting device 10a as a reference or starting point (from 0 to 500 sheets). A second set of gradients 16b counts the number of 100 weight coated paper cover sheets 22 using the right edge of the counting device 10a as a reference or starting point (from 0 to 500 sheets). A third set of gradients 16c counts the number of 80 weight coated paper text sheets 24 using the left edge of the counting device 10a as a reference or starting point (from 0 to 500 sheets). A fourth set of gradients 16d counts the number of 80 weight coated paper cover sheets 26 using the left edge of the counting device 10a as a reference or starting point (from 0 to 500 sheets).

Referring to FIG. 3B, a plan view of the present invention calibrated for card stock is shown. In this example, the counting device 10b has gradients 16 for measuring the number of sheets of card stock in a stack. A first set of gradients 16e counts the number of 67 weight card stock 30 using the right edge of the counting device 10b as a reference or starting point (from 0 to 400 sheets). A second set of gradients 16f counts the number of 100 weight card stock 32 using the right edge of the counting device 10b as a reference or starting point (from 0 to 400 sheets). A third set of gradients 16g counts the number of 65 weight card stock 34 using the left edge of the counting device 10b as a reference or starting point (from 0 to 400 sheets). A fourth set of gradients 16h counts the number of 80 weight card stock 36 using the left edge of the counting device 10b as a reference or starting point (from 0 to 400 sheets). It is anticipated that the counting device 10b either be a stand alone device or be on the back side of the previous counting device 10a.

Although shown in a particular arrangement, it is anticipated that any combination or mix of gradient scales 16 be implemented to meet the needs of the users. The examples provided here within are one possible combination that is suited for an organization that works with various types of paper stock, such as a copier company, printing company, etc. In such, it is often desired to know how many sheets of a certain stock are available before committing to a particular job.

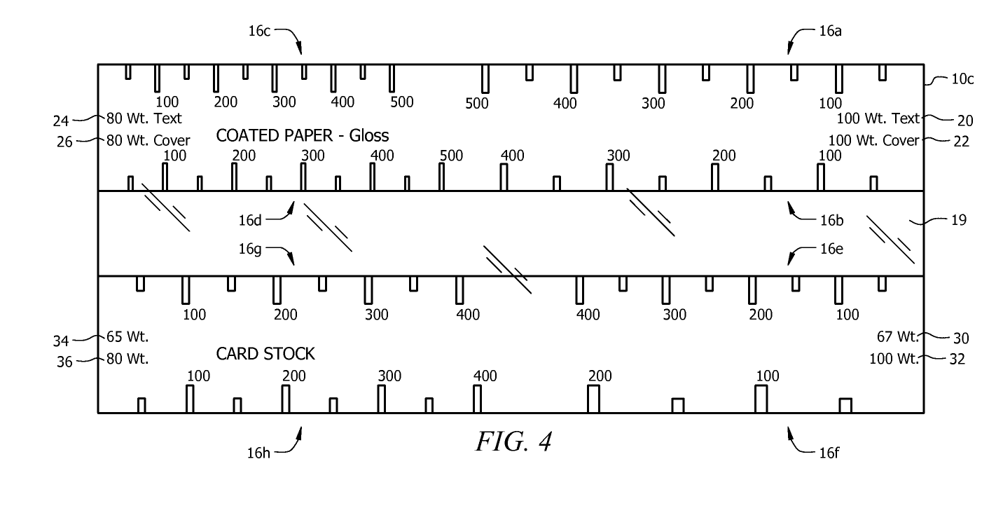

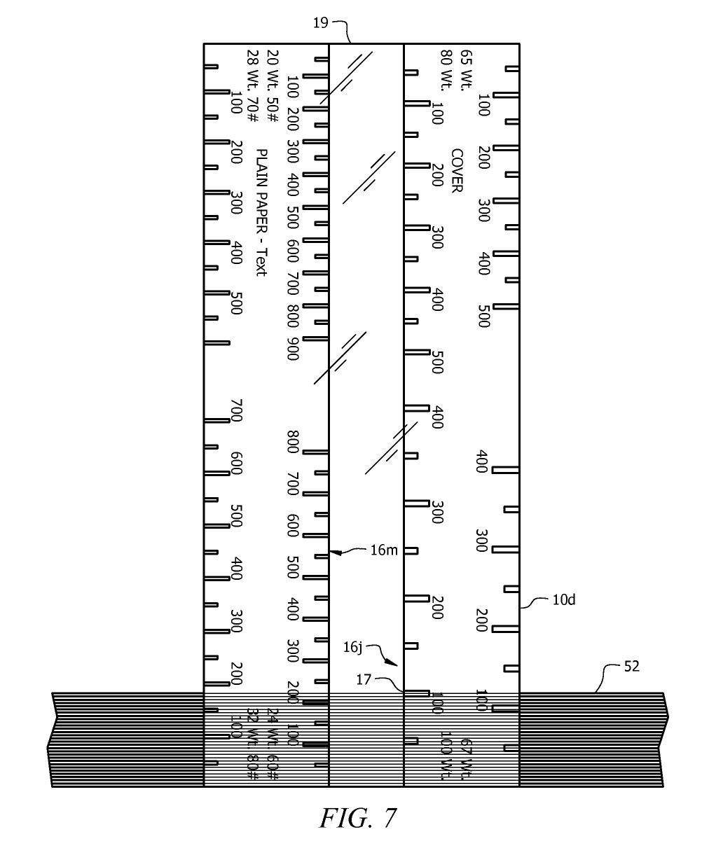

Referring to FIG. 4, a plan view of the present invention calibrated for several stacked objects is shown. In this example, eight sets of gradients 16a-16h are provided on one side of a counting device 10c. This counting device 10c has a central transparent area 19, through which, the objects being counted are visible to align with the inner 4 sets of gradients 16b, 16e, 16d and 16g. As shown in FIG. 7, the objects being counted 52 are visible through the central transparent area 19 so that an adjacent gradient 17 is alignable with the objects 52 to determine how many objects 52 are in the linear collection.

In this example, the counting device 10c has gradients 16 for measuring the number of sheets of coated paper in a stack and gradients 16 for measuring the number of sheets of card stock in a stack. A first set of gradients 16a counts the number of 100 weight text sheets 20 using the right edge of the counting device 10c as a reference or starting point. A second set of gradients 16b counts the number of 100 weight cover sheets 22 using the right edge of the counting device 10c as a reference or starting point (through the transparent window 19). A third set of gradients 16c counts the number of 80 weight text sheets 24 using the left edge of the counting device 10c as a reference or starting point. A fourth set of gradients 16d counts the number of 80 weight cover sheets 26 using the left edge of the counting device 10c as a reference or starting point (through the transparent window 19). A fifth set of gradients 16e counts the number of 67 weight card stock 30 using the right edge of the counting device 10c as a reference or starting point (through the transparent window 19). A sixth set of gradients 16f counts the number of 100 weight card stock 32 using the right edge of the counting device 10c as a reference or starting point. A seventh set of gradients 16g counts the number of 65 weight card stock 34 using the left edge of the counting device 10c as a reference or starting point (through the transparent window 19). An eighth set of gradients 16h counts the number of 80 weight card stock 36 using the left edge of the counting device 10c as a reference or starting point. It is anticipated that the counting device 10c, in some embodiments, have more gradients on the reverse side (not visible).

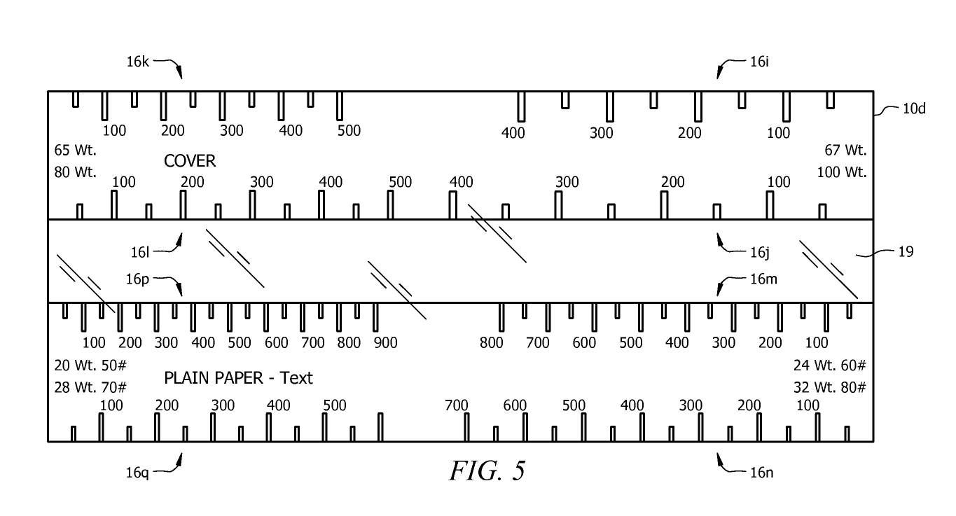

Referring to FIG. 5, a plan view of the present invention calibrated for a set of stacked paper objects is shown. In this example, eight sets of gradients 16i-16q are provided on one side of a counting device 10d. In this, the counting device 10d has a central transparent area 19, through which, the objects being counted are visible to align with the inner 4 sets of gradients 16j, 16m, 16l and 16p. As shown in FIG. 7, the objects being counted 52 are visible through the central transparent area 19 so that an adjacent gradient 16 is alignable with the objects 52 to determine how many objects 52 are in the linear collection.

In this example, the counting device 10d has gradients 16 for measuring the number of sheets of cover paper in a stack and gradients 16 for measuring the number of sheets of plain paper in a stack. A first set of gradients 16i counts the number of 67 weight cover sheets using the right edge of the counting device 10d as a reference or starting point. A second set of gradients 16j counts the number of 100 weight cover sheets using the right edge of the counting device 10d as a reference or starting point (through the transparent window 19). A third set of gradients 16k counts the number of 65 weight cover sheets using the left edge of the counting device 10d as a reference or starting point. A fourth set of gradients 16l counts the number of 80 weight cover sheets using the left edge of the counting device 10d as a reference or starting point (through the transparent window 19). A fifth set of gradients 16m counts the number of 24 weight plain paper sheets using the right edge of the counting device 10d as a reference or starting point (through the transparent window 19). A sixth set of gradients 16n counts the number of 32 weight paper sheets using the right edge of the counting device 10d as a reference or starting point. A seventh set of gradients 16p counts the number of 20 weight paper sheets using the left edge of the counting device 10d as a reference or starting point (through the transparent window 19). An eighth set of gradients 16q counts the number of 28 weight paper sheets using the left edge of the counting device 10d as a reference or starting point. It is anticipated that the counting device 10d, in some embodiments, have more gradients on the reverse side, for example, in some embodiments, the gradients of FIG. 4 are printed on the reverse side of the counting device 10d of FIG. 5.

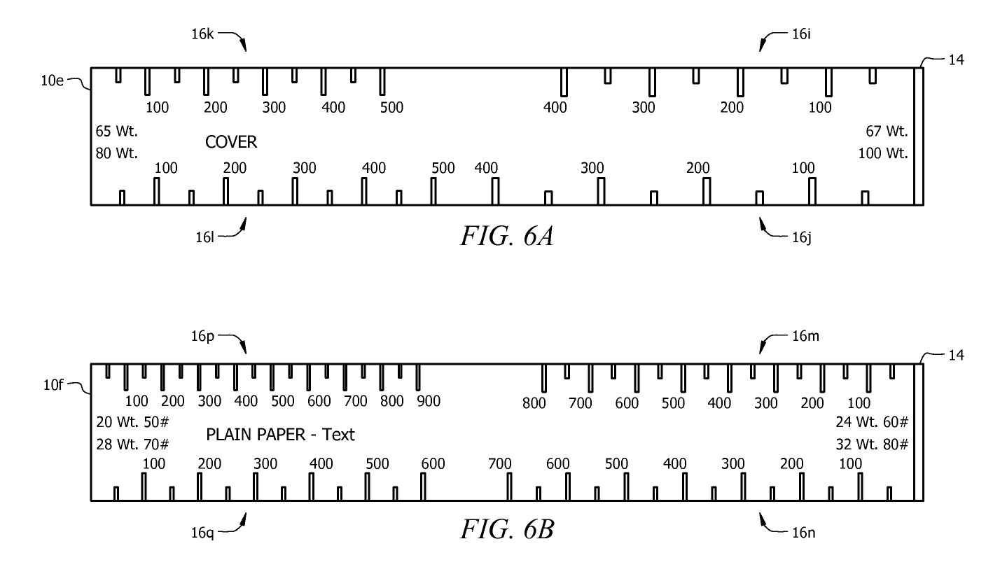

Referring to FIG. 6A, a plan view of the present invention calibrated for cover paper is shown. In this example, the counting device 10e has gradients 16 for measuring the number of sheets of cover paper in a stack. A first set of gradients 16i counts the number of 67 weight cover sheets using the ledge 14 of the counting device 10e as a reference or starting point (up to 500 sheets). A second set of gradients 16j counts the number of 100 weight cover sheets using the ledge 14 of the counting device 10e as a reference or starting point (up to 500 sheets). A third set of gradients 16k counts the number of 65 weight cover sheets using the ledge 14 of the counting device 10e as a reference or starting point (up to 500 sheets). A fourth set of gradients 16l counts the number of 80 weight cover sheets using the ledge 14 of the counting device 10e as a reference or starting point (up to 500 sheets).

Referring to FIG. 6B, a plan view of the present invention calibrated for plain paper is shown. In this example, the counting device 10f has gradients 16 for measuring the number of sheets of plain paper in a stack. A first set of gradients 16m counts the number of 24 weight plain paper sheets using the ledge 14 of the counting device 10f as a reference or starting point (up to 900 sheets). A second set of gradients 16n counts the number of 32 weight paper sheets using the ledge 14 of the counting device 10f as a reference or starting point (up to 700 sheets). A third set of gradients 16p counts the number of 20 weight paper sheets using the ledge 14 of the counting device 10f as a reference or starting point (up to 900 sheets). A fourth set of gradients 16q counts the number of 28 weight paper sheets using the ledge 14 of the counting device 10f as a reference or starting point (up to 700 sheets). It is anticipated that the counting device 10f, in some embodiments, have more gradients on the reverse side, for example, in some embodiments, the gradients of FIG. 6A are printed on the reverse side of the counting device 10f of FIG. 6B.

Referring to FIG. 7, a plan view of the present invention calibrated for a set of stacked paper objects shown measuring a number of objects in the stack 52 is shown. In this example of using the counting device 10d (see FIG. 5), the counting device 10d is aligned next to a stack of 100 weight cover sheets 52 and the cover sheets 52 are visible through the window 19. Since the stack 52 is of 100 weight cover sheets, the gradients for 100 weight cover sheets 16j are used and the top of the stack 52 aligns with the 100 mark 17 of the corresponding gradient 16j, therefore, it is known that there are 100 sheets of 100 weight cover sheets in the stack 52. If the stack 52 was, instead, 24 weight plain paper; then the gradient scale 16m for 24 weight plain paper is used and approximately 225 sheets of 24 weight plain paper are in the stack 52.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A counting device comprising:
an elongated body having a first end, a distal second end, a front surface, a back surface, a first side edge and a second side edge, the side edges running from the first end to the second end;
a plurality of gradients on the front surface of the elongated body, the gradients in proximity to least one of the first and second side edges, the gradients spaced and labeled corresponding to a specific set of homogeneous objects to be counted, each gradient representing a number of the homogeneous objects to be counted.

2. The counting device of claim 1, wherein the set of homogeneous objects are sheets of paper.

3. The counting device of claim 1, wherein the set of homogeneous objects are sheets of wood products.

4. The counting device of claim 1, wherein a first set of the gradients is spaced and labeled along the first side edge and a second set of the gradients is spaced and labeled along the second side edge, the first set of the gradients counting a number of a first type of the homogeneous objects and the second set of gradients counting a number of a second type of the homogeneous objects.

5. The counting device of claim 4, further comprising a third and fourth set of gradients, the third set of gradients spaced and labeled on a back side of the elongated body along the first side edge and the fourth set of gradients spaced and labeled on the back side of the elongated body along the second side edge, the third set of the gradients spaced and marked counting a number of a third type of the homogeneous objects and the fourth set of gradients spaced and marked counting a number of a fourth type of homogeneous objects.

6. The counting device of claim 1, further comprising a transparent section running lengthwise from the first end of the elongated body to the second end of the elongated body, a second plurality of gradients on the front surface of the elongated body in proximity to the transparent section, the second set of gradients spaced and labeled according to a second specific set of homogeneous objects to be counted, each gradient representing a number of the homogeneous objects to be counted.

7. The counting device of claim 6, further comprising a third plurality of gradients on the back surface of the elongated body in proximity to the transparent section, the third set of gradients spaced and labeled according to a third set of the homogeneous objects to be counted, each gradient representing a number of the homogeneous objects to be counted.

8. The counting device of claim 1, further comprising a ledge disposed at the first end of the elongated body.

9. The counting device of claim 7, further comprising a caliper slideably engaged with the elongated body, a stack of the homogeneous objects placed between the caliper and the ledge.

10. A method of counting homogeneous objects comprising:
providing a counting device comprising:
an elongated body having a first end, a distal second end, a front surface, a back surface, a first side edge and a second side edge, the side edges running from the first end to the second end;
a plurality of gradients on a surface of the elongated body, at least a subset of the gradients in proximity to at least one of the first and second side edges, the gradients spaced and labeled according to a specific set of homogeneous objects to be counted, each gradient representing a number of the homogeneous objects to be counted
placing the counting device next to a linear collection of the homogeneous objects such that the first end of the elongated body is positioned next to a first end object of the linear collection of homogeneous objects; and
reading a count of the homogeneous objects from a gradient marker that aligns with a distal end object of the linear collection of homogeneous objects.

11. The method of claim 10, wherein the homogeneous objects are sheets of paper and there are sets of gradients, each set of gradients corresponding to a specific type of the paper.

12. The method of claim 10, wherein the homogeneous objects are sheets of plywood and there are sets of gradients, each set of gradients corresponding to a specific thickness and type of the plywood.

13. The method of claim 10, wherein the homogeneous objects are sheets of paper and there are four sets of the gradients, a first set of the gradients is spaced for 24 weight plain paper, a second set of the gradients is spaced for 32 weight plain paper, a third set of the gradients is spaced for 20 weight plain paper, a fourth set of the gradients is spaced for 28 weight plain paper.

14. A counting device comprising:
a means for measuring a height of a linear collection of homogeneous objects, the means for measuring directly indicating a number of the homogeneous objects in the linear collection of homogeneous objects.

15. The counting device of claim 14, wherein the linear collection of homogeneous objects is a stack of sheets of paper, all of the sheets of the paper being of a same thickness.

16. The counting device of claim 14, wherein the linear collection of homogeneous objects is a stack of sheets of wood products, all of the sheets of the wood products being of a same thickness.

17. The counting device of claim 14, wherein the means for measuring has a first set of the gradients and a second set of the gradients, the first set of the gradients spaced to count a number of a first type of a first homogeneous object and the second set of gradients spaced to count a number of a second type of homogeneous object.

18. The counting device of claim 17, further comprising a third and fourth set of gradients, the third set of gradients spaced to count a number of a third type of homogeneous objects and the fourth set of gradients spaced to count a number of a fourth type of homogeneous object.

19. The counting device of claim 14, further comprising a means for registering against a side of a first of the homogeneous objects.

20. The counting device of claim 14, further comprising a means for registering against a side of a last of the homogeneous objects, the set of the homogeneous objects placed between the means for registering against the side of the first of the homogeneous objects and the means for registering against the side of the last of the homogeneous objects.
